(19) United States
(12) Patent Application Publication
(10) Pub. No.: US 2015/0066863 A1
(43) Pub. Date: Mar. 5, 2015

(54) EXPIRATION OF RECORDS OF A WEB-BASED DISCUSSION

(71) Applicant: Trevor Michael SEHRER, San Francisco, CA (US)

(72) Inventor: Trevor Michael SEHRER, San Francisco, CA (US)

(73) Assignee: GOOGLE INC., Mountain View, CA (US)

(21) Appl. No.: 13/296,194

(22) Filed: Nov. 14, 2011

(51) Int. Cl. G06F 17/30

(52) U.S. Cl. 707/663; 707/E17.009

(57) ABSTRACT

A system and machine-implemented method for expiring records of a web-based discussion is provided. A time value associated with a web-based discussion is received from one of several participants of the discussion. A record of the web-based discussion is stored. The record of the web-based discussion is deleted according to the received time value.

### BACKGROUND

The present disclosure generally relates to web-based discussion tools and expiration of records of a web-based discussion.

Web-based discussions may be used by several participants to communicate with one another in real-time or in an asynchronous fashion. In certain instances, the communicated text may be stored on a storage device to be retrieved for review at a later time. The communicated text may be stored for an indefinite amount of time.

For example, a web-based forum may provide a medium for which multiple participants can communicate online. An original participant may initiate a discussion thread on the web-based forum to which additional participants may post. Once the thread has been created, the thread, including all entries posted by the participants, remains on the web-based forum. Thus, it may be desirable for a system that hosts a web-based forum to delete records of the thread.

### SUMMARY

The disclosed subject matter relates to a machine-implemented method for expiring records of a web-based discussion. A web-based discussion between several participants is initiated. A user-specified expiration time value associated with the web-based discussion is received from one of the several participants. Electronic records of the discussion for entries by each of the several participants are stored. Records of the discussion are deleted at the user-specified expiration time value.

According to various aspects of the subject technology, a system for hosting web-based discussions is provided. The system comprises one or more servers connected to one or more client devices (e.g., desktop, mobile, or other compute devices) via a network (e.g., the Internet, a wide area network, a local area network, etc.). The one or more servers is also connected to one or more host databases for storing web-based discussion threads. Each server comprises a participant management module and an expiration determination module. Upon request from a participant operating a client device, the participant management module of the server initiates a web-based discussion between several participants. The expiration determination module of the server further receives, from one of the several participants, a user-specified expiration time value associated with the web-based discussion. The several users operating the client devices post entries to the web-based discussion, and records of each posted entry are stored by the server on the host database until the user-specified expiration time. Records associated with the web-based discussion are deleted at the user-specified expiration time.

The disclosed subject matter also relates to a machine-readable medium comprising instructions stored therein, which when executed by a system, cause the system to perform operations comprising initiating a web-based discussion between several participants and receiving a user-specified expiration time value associated with the web-based discussion from one of the several participants. Electronic records of the discussion for entries by each of the several participants are stored, and records of the discussion are deleted at the user-specified expiration time value.

The disclosed subject matter further relates to a machine-implemented method for storing a web-based collaborative document. A document is received from one of several participants. A user-specified expiration time associated with the document is also received from the one participant from whom the document is received. Edits to the document from the several participants are received, and records of the edits to the document by the several participants are stored until the user-specified expiration time value. Records of the document including the edits by the several participants are deleted at the user-specified expiration time.

According to various aspects of the subject technology, a system for hosting web-based collaborative documents is provided. The system comprises one or more servers connected to one or more client devices via a network. The one or more servers is also connected to one or more host databases for storing the documents. Each server comprises a participant management module and an expiration determination module. Upon request from one of several participants operating a client device, the participant management module uploads a web-based collaborative document and the expiration determination module receives a user-specified expiration time value associated with the document from the client device. The participant management module further receives edits to the document from the several participants. Records of the edits to the document by the several participants are stored by the participant management module on the host database until the user-specified expiration time. Records of the document including the edits by the several participants are deleted by the expiration determination module at the user-specified expiration time.

The disclosed subject matter also relates to a machine-readable medium comprising instructions stored therein, which when executed by a system, cause the system to perform operations comprising receiving a document and a user-specified expiration time associated with the document from one of several participants. Edits to the document from the several participants are received, and records of the edits to the document by the several participants are stored until the user-specified expiration time value. Records of the document including the edits by the several participants are deleted at the user-specified expiration time.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment which provides for administering and storing web-based discussions/collaborations.

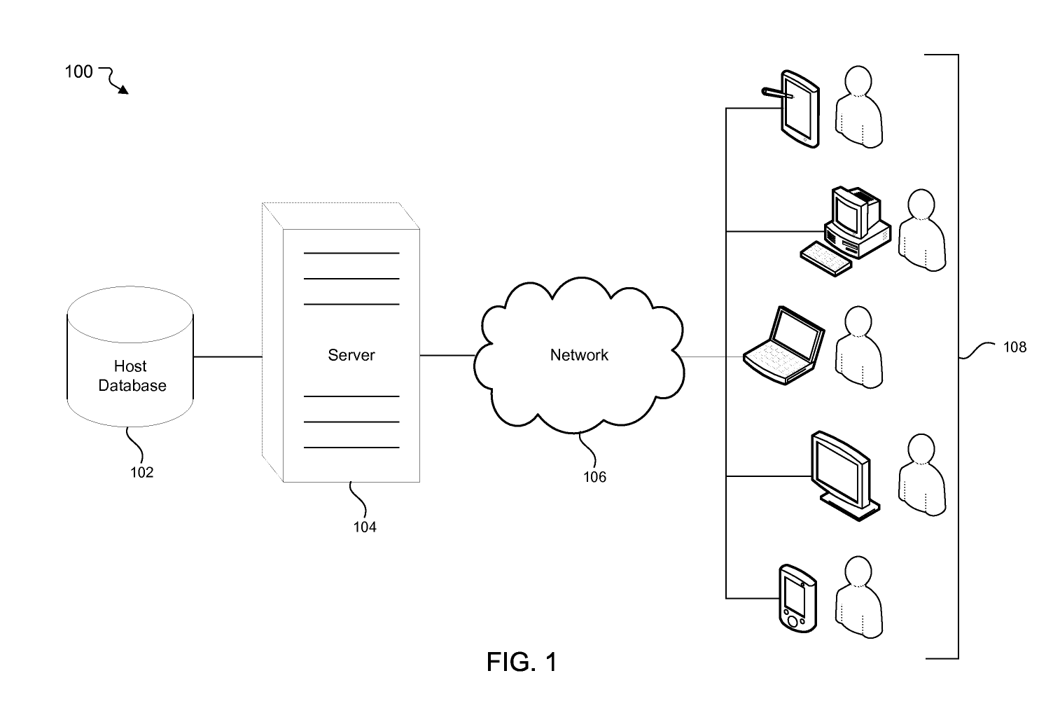

FIG. 2 illustrates an example of a server system for managing participation on web-based discussions/collaborations.

FIG. 3 illustrates an example method for administering a web-based discussion for which a user-specified expiration time is applied.

FIG. 4 provides a graphical representation of an example of participants engaged in a web-based discussion.

FIG. 5 illustrates an example method for administering a web-based document collaboration for which a user-specified expiration time is applied.

FIG. 6 provides a graphical representation of an example of participants engaged in a web-based document collaboration.

FIG. 7 illustrates an example user interface from which a web-based discussion with an applied user-specified expiration time may be initiated.

FIG. 8 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The disclosed subject matter describes systems and techniques for expiration of records of a web-based discussion. A web-based discussion between several participants is initiated. A user-specified expiration time value associated with the web-based discussion is received from one of the several participants. Electronic records of the discussion for entries by each of the several participants are stored. Records of the discussion are deleted at the user-specified expiration time value.

A participant initiates a web-based discussion through a request from a client device. The participant may also provide an expiration time associated with the discussion. This expiration time is the time at which the participant desires to have records of the discussion deleted. Records of the discussion, such as entries posted by any of several participants, are stored until the expiration time. Records of the discussion are deleted at the user-specified expiration time value.

Network environment 100 comprises one or more host databases 102 (e.g., computer-readable storage devices) for storing a plurality of web-based discussions, and for storing web-based collaborative documents. The network environment 100 further comprises one or more servers 104. Server 104 may serve the associated discussions and documents from host database 102 to the client devices 108 upon request by client devices 108. Each of client devices 108 can represent various forms of processing devices. Example processing devices can include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices.

Server 104 may also store entries received from participants operating client devices 108. Server 104 and client devices 108 may be communicatively coupled through a network 106. In some implementations, client devices 108 may initiate a web-based discussion that may be stored on a host database by server 104. In some implementations, documents may be uploaded to host database 102 for retrieval and editing by participants operating client devices 108.

In some aspects, client devices 108 may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

In some aspects, network environment 100 can be a distributed client/server system that spans one or more networks such as network 106. Network 106 can be a large computer network, such as a local area network (LAN), wide area network (WAN), the Internet, a cellular network, or a combination thereof connecting any number of mobile clients, fixed clients, and servers. In some aspects, each client (e.g., client devices 108) can communicate with servers 104 via a virtual private network (VPN), Secure Shell (SSH) tunnel, or other secure network connection. In some aspects, network 106 may further include a corporate network (e.g., intranet) and one or more wireless access points.

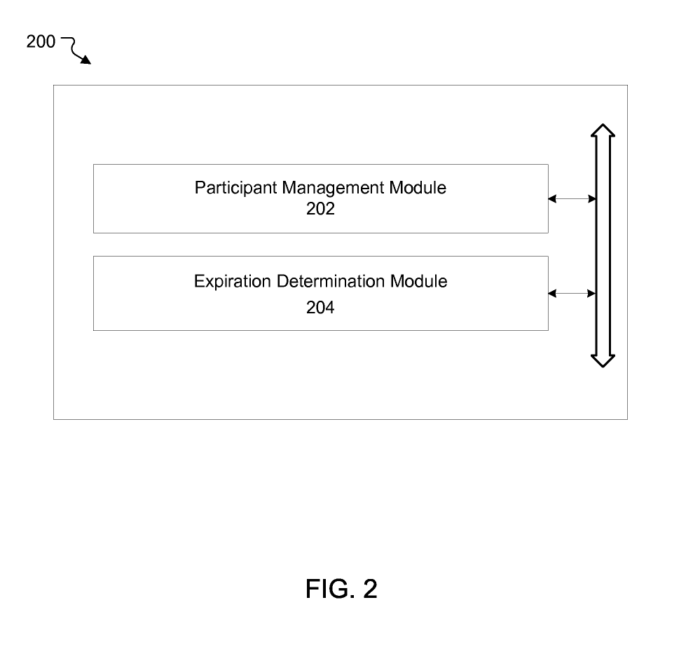

FIG. 2 illustrates an example of a system utilized for managing participation on web-based discussions/collaborations. System 200 includes participant management module 202 and expiration determination module 204. These modules, which are in communication with one another, process information retrieved from client devices 108 to administer and store web-based discussions/collaborations. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

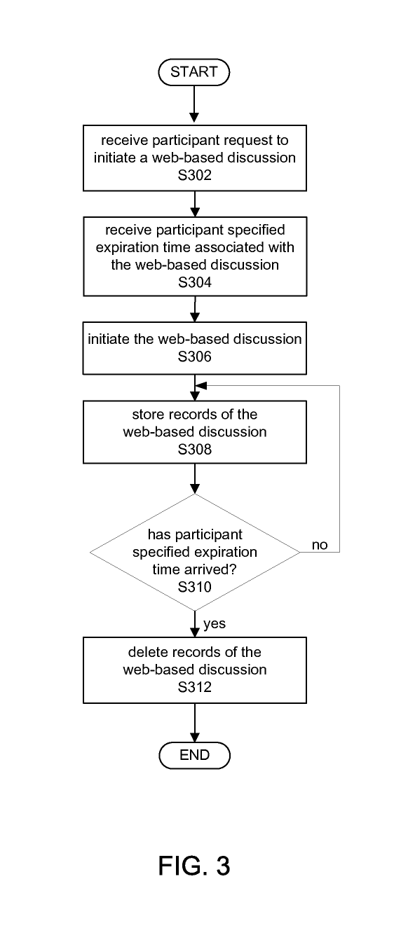

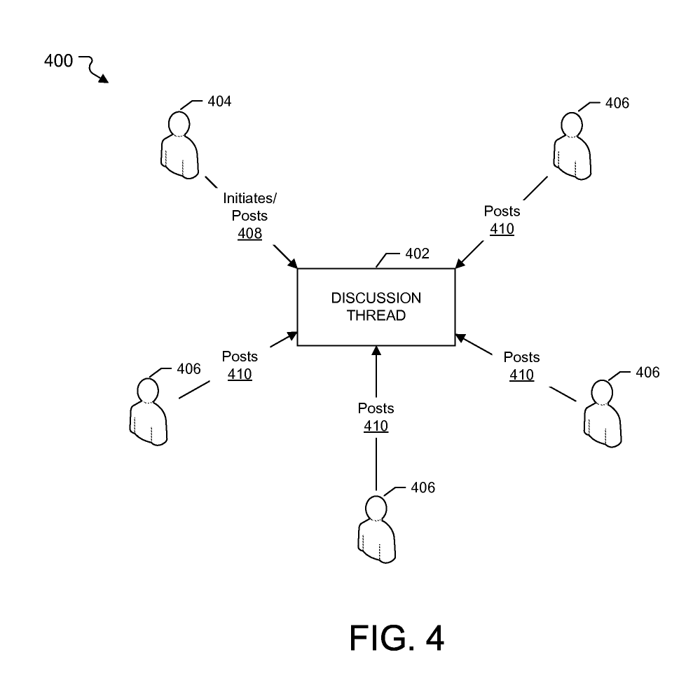

FIG. 3 illustrates example method 300 for administering a web-based discussion for which a user-specified expiration time is applied. While the process of FIG. 3 will be described with reference to FIGS. 2 and 4, it should be noted that the process is not limited to the configurations and environments of FIGS. 2 and 4, and that the process can apply to other configurations and/or environments. FIG. 4 provides a graphical representation of an example of participants engaged in a web-based discussion. While FIG. 4 illustrates an example that includes one original participant 404 and four additional participants 406 participating in a single discussion thread 402, numerous additional participants may participate in numerous discussion threads simultaneously.

Returning to FIGS. 2 and 3, participant management module 202 may receive a request to initiate a web-based discussion, according to S302. FIG. 4 illustrates an example of original participant 404 initiating 408 discussion thread 402 in which additional participants 406 may post 410 entries. Participant management module 202 may further receive a participant specified expiration time associated with the web-based discussion, according to S304. The participant specified expiration time may be a time at which the participant desires to have records of the discussion deleted. In an exemplary implementation, authority to set the expiration time may be granted to original participant 404 who initiates a discussion thread 402.

Participant management module 202 may initiate the web-based discussion based on the received request, according to S308. Additional participants 406 may post 410 entries to the discussion thread 402. Records of each entry posted by additional participants 406 may be stored by participant management module 202 on host database 102 for retrieval at a later time, according to S308. Expiration determination module 204 queries whether the participant specified expiration time has arrived, according to S310. When the expiration time has yet to arrive, participant management module 202 continues to store records of the discussion, according to S308. However, when the expiration time arrives, records of the web-based discussion, including posts by the original and additional participants, may be deleted from the system. That is, all records of the discussion may be removed from host database 102. Records that have been deleted from the system may no longer be retrievable.

Examples of the above-mentioned web-based discussions include, but are not limited to, social networking sites, online forums/discussion boards, and online chats. Social networking sites generally provide sections within a user's profile where visitors may post text, pictures, and/or hyperlinks that are publicly viewable. Similarly, online forums/discussion boards provide sections corresponding to user created topics to which visitors may read and post entries. Online chats, while not viewable by non-participants, may store histories of conversations which a user may not want to keep. Thus, it may be desirable to implement a system that deletes records of web-based discussions based on a user-specified expiration time.

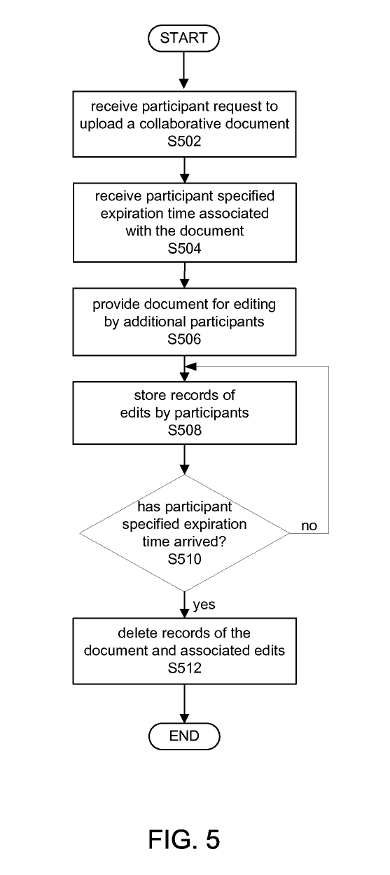

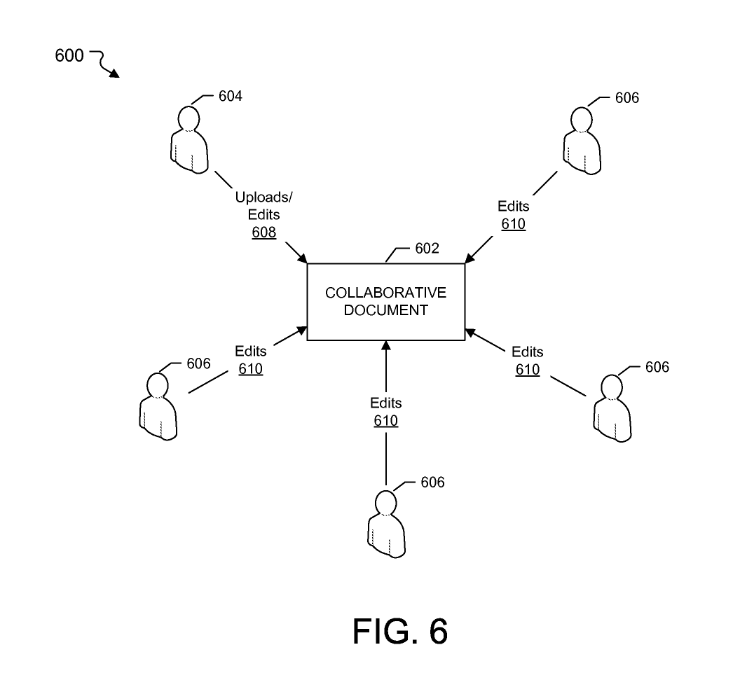

FIG. 5 illustrates example method 500 for administering a web-based document collaboration for which a user-specified expiration time is applied. While the process of FIG. 5 will be described with reference to FIGS. 2 and 6, it should be noted that the process is not limited to the configurations and environments of FIGS. 2 and 6, and that the process can apply to other configurations and/or environments. FIG. 6 provides a graphical representation of an example of participants engaged in web-based collaborative document editing. While FIG. 6 illustrates an example that includes an initial participant 604 that uploads the collaborative document 602 and four additional participants 606 engaged in the single collaborative document 602, numerous additional participants may be engaged in numerous collaborative documents simultaneously.

Returning to FIGS. 2 and 5, participant management module 202 may receive a request to upload a collaborative document, according to S502. FIG. 6 illustrates an example of initial participant 604 uploading 608 collaborative document 602 in order to allow collaborative editing 610 by additional participants 606. Participant management module 202 may further receive a participant specified expiration time associated with the collaborative document 602, according to S504. The participant specified expiration time may be a time at which the participant desires to have records of the discussion deleted. In an exemplary implementation, authority to set the expiration time may be granted to initial participant 604 who uploads the collaborative document 602.

Participant management module 202 may provide the document for editing based on the received request, according to S508. Additional participants 606 may edit 610 the collaborative document 602. Records of each edit by additional participants 606 may be stored by participant management module 202 on host database 102 for retrieval at a later time, according to S508. Expiration determination module 204 queries whether the participant specified expiration time has arrived, according to S510. When the expiration time has yet to arrive, participant management module 202 continues to store records of the participant edits, according to S508. However, when the expiration time arrives, records of the web-based discussion, including posts by the initial and additional participants, may be deleted from the system. That is, all records of the collaborative document may be removed from host database 102. Documents that have been deleted from the system may no longer be retrievable.

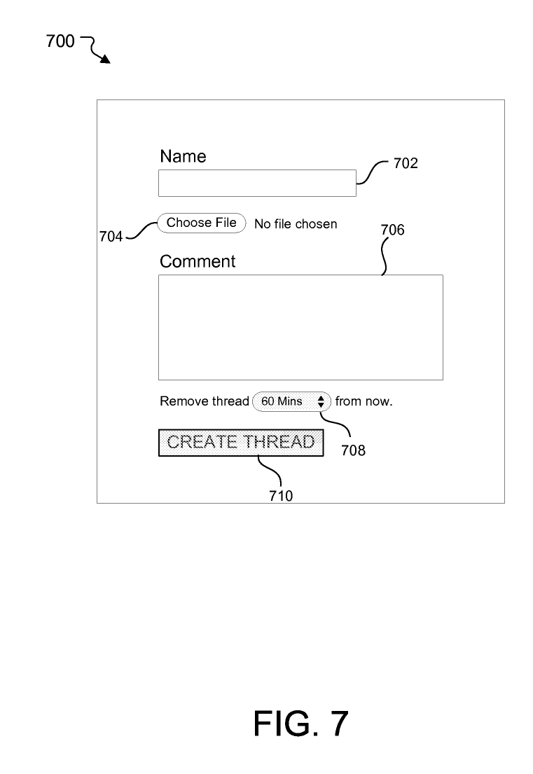

FIG. 7 provides an illustration of an example user interface 700 from which a web-based discussion with an applied user-specified expiration time may be initiated. The user interface may include name section 702 in which a participant may enter an identifier (e.g., given name, nickname, screen name, etc.). In a web-based discussion, the name field may be used to identify the person that created the discussion thread. User interface 700 may allow the user to attach a file via button 704. For example, in a web-based collaborative document editing application, a participant may attach a document to be uploaded for the purpose of collaborative editing with other participants. User interface 700 may further provide text box 706 for a user to enter text corresponding to the discussion the user would like to initiate. Expiration time selection box 708 may be provided to allow the user to select a duration for which the user would like the discussion thread to remain retrievable. Selection box 708 may include a variety of values from which a user may select. Create thread button 710 initiates a new thread when activated by a user. The newly-created thread maintains the values entered in user interface 700. For example, the name and comment entered into user interface 700 may be displayed and publicly viewed. Additionally, any attached files may also be accessible to other participant. The created thread will also include an expiration time as specified by selection box 708 at the time the thread is created.

While the above discussions refer to the expiration time as a duration, the expiration time may alternatively be defined as a specific date and time in some implementations. That is, instead of setting the expiration as a duration from the time a web-based discussion is created, the user may indicate a date and time at which the user would like the records of the discussion to be deleted. In some implementations, the expiration time may also be modifiable after an initial expiration time is set during the creation of the thread. In some implementations, the expiration time may be determined based on a vote by all participants in a discussion thread. Additionally, it may be desirable to provide a counter indicating an amount of time left before the expiration of a discussion.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

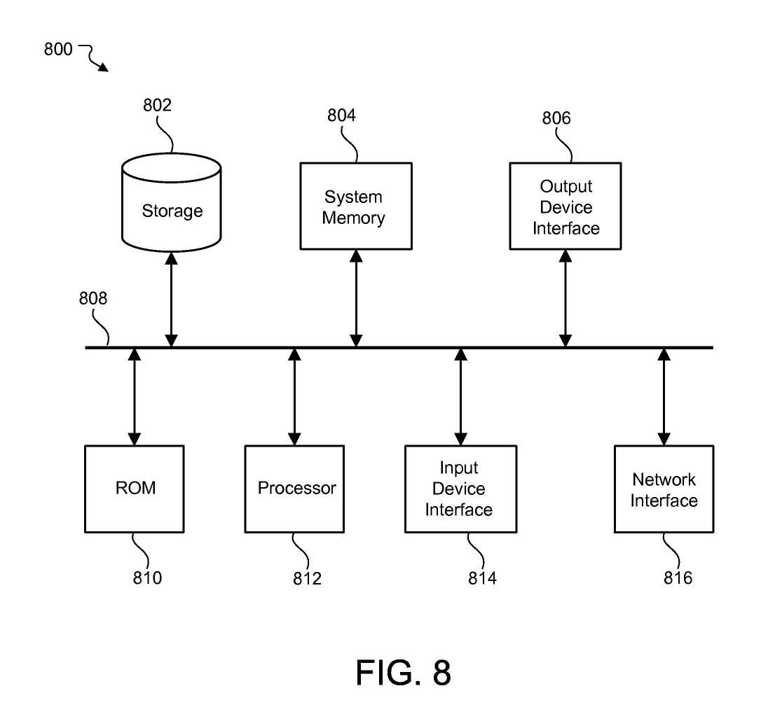

FIG. 8 conceptually illustrates an example electronic system with which some implementations of the subject technology are implemented. Electronic system 800 can be a computer, phone, PDA, or any other sort of electronic device. Such an electronic system includes various types of computer readable media and interfaces for various other types of computer readable media. Electronic system 800 includes a bus 808, processing unit(s) 812, a system memory 804, a read-only memory (ROM) 810, a permanent storage device 802, an input device interface 814, an output device interface 806, and a network interface 816.

Bus 808 collectively represents all system, peripheral, and chipset buses that communicatively connect the numerous internal devices of electronic system 800. For instance, bus 808 communicatively connects processing unit(s) 812 with ROM 810, system memory 804, and permanent storage device 802.

From these various memory units, processing unit(s) 812 retrieves instructions to execute and data to process in order to execute the processes of the subject disclosure. The processing unit(s) can be a single processor or a multi-core processor in different implementations.

ROM 810 stores static data and instructions that are needed by processing unit(s) 812 and other modules of the electronic system. Permanent storage device 802, on the other hand, is a read-and-write memory device. This device is a non-volatile memory unit that stores instructions and data even when electronic system 800 is off. Some implementations of the subject disclosure use a mass-storage device (such as a magnetic or optical disk and its corresponding disk drive) as permanent storage device 802.

Other implementations use a removable storage device (such as a floppy disk, flash drive, and its corresponding disk drive) as permanent storage device 802. Like permanent storage device 802, system memory 804 is a read-and-write memory device. However, unlike storage device 802, system memory 804 is a volatile read-and-write memory, such as random access memory. System memory 804 stores some of the instructions and data that the processor needs at runtime. In some implementations, the processes of the subject disclosure are stored in system memory 804, permanent storage device 802, and/or ROM 810. For example, the various memory units include instructions for updating the status of an email message in accordance with some implementations. From these various memory units, processing unit(s) 812 retrieves instructions to execute and data to process in order to execute the processes of some implementations.

Bus 808 also connects to input and output device interfaces 814 and 806. Input device interface 814 enables the user to communicate information and select commands to the electronic system. Input devices used with input device interface 814 include, for example, alphanumeric keyboards and pointing devices (also called “cursor control devices”). Output device interface 806 enables, for example, the display of images generated by the electronic system 800. Output devices used with output device interface 806 include, for example, printers and display devices, such as cathode ray tubes (CRT) or liquid crystal displays (LCD). Some implementations include devices such as a touchscreen that functions as both input and output devices.

Finally, as shown in FIG. 8, bus 808 also couples electronic system 800 to a network (not shown) through a network interface 816. In this manner, the computer can be a part of a network of computers (such as a local area network (“LAN”), a wide area network (“WAN”), or an Intranet, or a network of networks, such as the Internet. Any or all components of electronic system 800 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method of deleting records of a web-based discussion, the method comprising:
determining an expiration time value associated with a web-based discussion, wherein the web-based discussion is between a plurality of participants and the expiration time value is determined based on a vote by the plurality of participants engaged in the web-based discussion;
storing a record of the web-based discussion; and
deleting the record of the web-based discussion according to the received expiration time value.

2. The method of claim 1, wherein the expiration time value is specified as a date and a time, and wherein the record of the web-based discussion is deleted at the specified date and time.

3. The method of claim 1, wherein the expiration time value is specified as a duration including at least one of seconds, minutes, hours, or days, and wherein the deleting the record comprises deleting the record of the web-based discussion when the specified duration has elapsed.

4. The method of claim 1, wherein the expiration time value associated with the web-based discussion is modifiable by the participant who specified the expiration time value.

5-6. (canceled)

7. The method of claim 1, wherein the web-based discussion comprises textual communication.

8. The method of claim 7, wherein the textual communication comprises one of a text chat room, a message board, a social networking site, or an instant messaging conversation.

9. (canceled)

10. A non-transitory machine-readable medium comprising instructions stored therein, which when executed by a machine, cause the machine to perform operations comprising:
initiating a web-based discussion for a plurality of participants for which an electronic record is stored;
determining an expiration time value associated with the web-based discussion, wherein the expiration time value is determined based on a vote by the plurality of participants for which the electronic record is stored; and
deleting the record of the web-based discussion according to the received expiration time value.

11. The non-transitory machine-readable storage medium of claim 10, wherein the participant specifying the expiration time value associated with the web-based discussion corresponds to an individual delegated with moderating the web-based discussion.

12. The non-transitory machine-readable storage medium of claim 10, wherein the expiration time value is specified as a date and a time, and wherein the record of the web-based discussion is deleted at the specified date and time.

13. The non-transitory machine-readable storage medium of claim 10, wherein the expiration time value is specified as a duration including at least one of seconds, minutes, hours, or days, and wherein the deleting the record comprises deleting the record of the web-based discussion when the specified duration has elapsed.

14. The non-transitory machine-readable storage medium of claim 13, wherein the expiration time value associated with the web-based discussion is modifiable by the participant who specified the expiration time value.

15. The non-transitory machine-readable storage medium of claim 10, the operations further comprising providing notice of an amount of time remaining until deletion of the record.

16. The non-transitory machine-readable storage medium of claim 10, wherein the web-based discussion is hosted on a server.

17. The non-transitory machine-readable storage medium of claim 16, the operations further comprising locking the record so as to reduce propagation of the record from the server to a local machine.

18. The non-transitory machine-readable storage medium of claim 10, wherein the web-based discussion comprises textual communication, and wherein the textual communication comprises one of a text chat room, a message board, or an instant messaging conversation.

19. A system for hosting web-based collaborative documents, the system comprising:
one or more processors; and
a machine-readable medium comprising instructions stored therein, which when executed by the processors, cause the processors to perform operations comprising:
receiving, from a participant of a plurality of participants, a document for collaborative editing;
determining an expiration time value associated with the received document based on a vote by the plurality of participants;
receiving, from the plurality of participants, edits to the document;
updating electronic records of edits based on edits received from the plurality of participants; and
deleting the electronic records of the web-based collaborative document according to the received expiration time value.

20. The system of claim 19, wherein the expiration time value is specified as a duration including at least one of seconds, minutes, hours, or days, and wherein the deleting the records comprises deleting the records of the web-based collaborative document when the specified duration has elapsed.
